(19) United States
(12) Patent Application Publication
(10) Pub. No.: US 2005/0128945 A1
(43) Pub. Date: Jun. 16, 2005

(54) Preventing a packet associated with a blocked port from being placed in a transmit buffer

(76) Inventors: Chen-Chi Kuo, Pleasanton, CA (US); David Chou, San Jose, CA (US); Lawrence B. Huston, Wexford, PA (US); Sridhar Lakshmanamurthy, Sunnyvale, CA (US); Uday Naik, Fremont, CA (US)

Correspondence Address: BUCKLEY, MASCHOFF, TALWALKAR LLC, 5 ELM STREET, NEW CANAAN, CT, 06840, US

(21) Appl. No.: 10/733,120

(22) Filed: Dec. 11, 2003

(51) Int. Cl. H04L 12/26; H04L 12/28; H04L 12/56

(52) U.S. Cl. 370/230; 370/252; 370/395.4; 370/412

(57) ABSTRACT

According to some embodiments, a packet associated with a blocked port is prevented from being placed in a transmit buffer.

### BACKGROUND

A network device may facilitate an exchange of information packets via a number of different ports. For example, a network processor may receive packets and arrange for each packet to be transmitted via an appropriate port. Moreover, it may be helpful to avoid unnecessary delays when processing the packets—especially when the network device is associated with a relatively high speed network.

### BRIEF DESCRIPTION OF THE DRAWINGS

FIG. 1 is a block diagram of an apparatus to transmit packets.

FIG. 2 is a block diagram of another apparatus to transmit packets.

FIG. 3 is a flow chart of a method according to some embodiments.

FIG. 4 is a block diagram of an apparatus according to some embodiments.

FIG. 5 is a flow chart of a transmit processing element method according to some embodiments.

FIG. 6 is a block diagram of an apparatus according to some embodiments.

FIG. 7 is a flow chart of a schedule processing element method according to some embodiments.

FIG. 8 is an example of a system including a network processor according to some embodiments.

### DETAILED DESCRIPTION

A network device may facilitate an exchange of information packets. As used herein, the phrase “network device” may refer to, for example, an apparatus that facilitates an exchange of information via a network, such as a Local Area Network (LAN), or a Wide Area Network (WAN). Moreover, a network device might facilitate an exchange of information packets in accordance with the Fast Ethernet LAN transmission standard 802.3-2002® published by the Institute of Electrical and Electronics Engineers (IEEE). Similarly, a network device may process and/or exchange Asynchronous Transfer Mode (ATM) information in accordance with ATM Forum Technical Committee document number AF-TM-0121.000 entitled “Traffic Management Specification Version 4.1” (March 1999). A network device may be associated with, for example, a network processor, a switch, a router (e.g., an edge router), a layer 3 forwarder, and/or protocol conversion. Examples of network devices include those in the INTEL® IXP 2400 family of network processors.

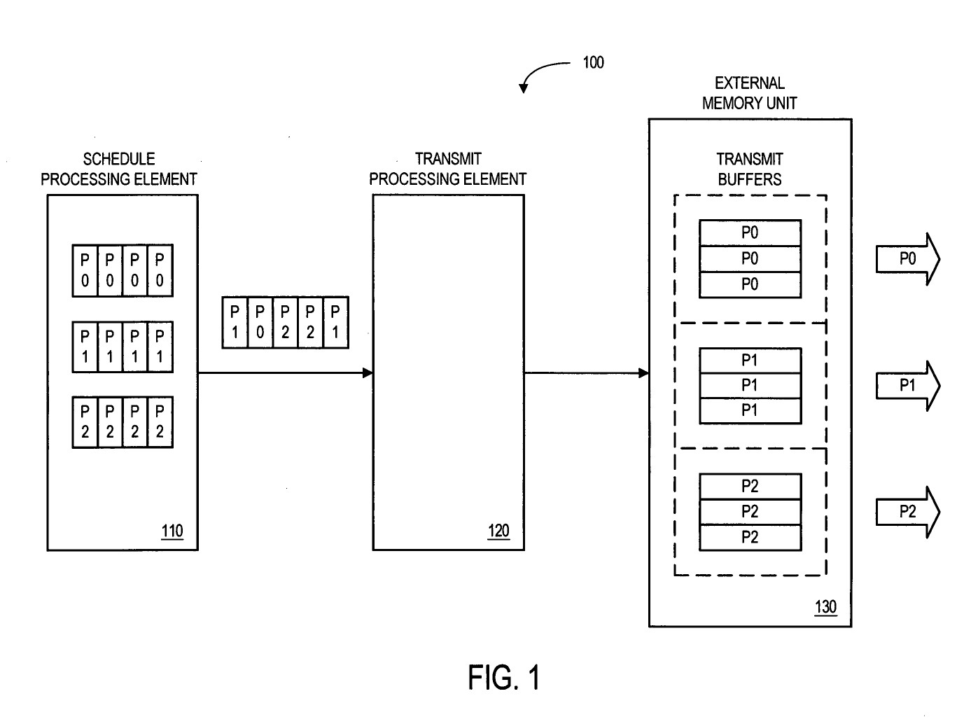

FIG. 1 is a block diagram of an apparatus 100 to transmit packets. In particular, the apparatus 100 includes a schedule processing element 110 that has information packets that will be transmitted via a number of different ports (e.g., P0 through P2). Although three ports are illustrated in FIG. 1, the apparatus 100 may include any number of ports.

The schedule processing element 110 determines when each packet should be transmitted and provides the packets to a transmit processing element 120 as appropriate. The packets may be scheduled, for example, based on quality of service parameters associated with each packet. The schedule processing element 110 and the transmit processing element 120 may comprise a series of multi-threaded, multi-processing Reduced Instruction Set Computer (RISC) devices or “microengines.” According to some embodiments, each processing element 110, 120 is associated with a functional block that performs ATM traffic management operations (e.g., scheduling or transmitting).

The transmit processing element 120 stores the packets in an external memory unit 130 (e.g., external to the transmit processing element 120), such as a Static Random Access Memory (SRAM) unit having a number of separate First-In, First-Out (FIFO) transmit buffers. Moreover, as illustrated in FIG. 1 each port may be associated with its own transmit buffer. That is, one transmit buffer may store packets to be transmitted via P0 while a separate transmit buffer stores packets to be transmitted P1. In this case, however, the amount of information that can be transmitted through a particular port might be unnecessarily limited. For example, when the flow of packets through P0 substantially exceeds the flow of packets through P1, the transmit buffer associated with P0 could become full (preventing additional packets from being stored in that transmit buffer) even though the transmit buffer associated with P1 is empty.

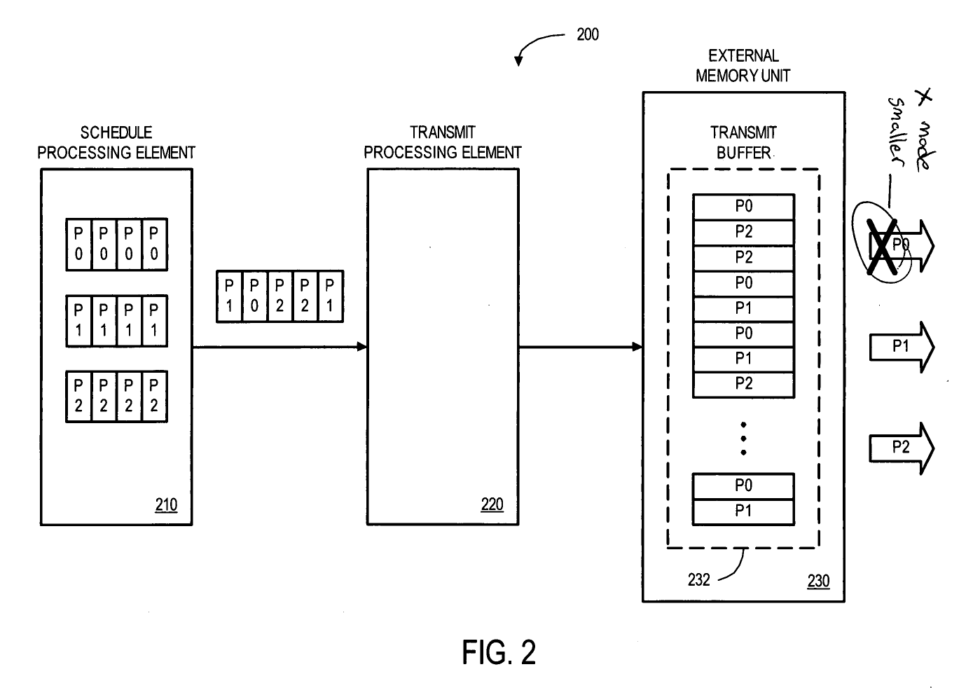

The reduce the likelihood such a problem, a single transmit buffer may store packets associated with a number of different ports. For example, FIG. 2 is a block diagram of another apparatus 200 to transmit packets. As before, the apparatus 200 includes a schedule processing element 210 that provides information packets to a transmit processing element 220.

The transmit processing element 220 stores the packets in an external memory unit 230. In this case, the packets are stored in a single FIFO transmit buffer 232. That is, the transmit buffer 232 might include the following packets (identified by port): P0, P2, P2, P0, P1 . . . . A hardware unit may then retrieve the packets in order and arrange for the packets to be transmitted via the appropriate port.

Note that using a single transmit buffer 232 for a number of different ports might introduce delays when one port is blocked. Consider, for example, a situation where P0 is currently blocked (e.g., because a downstream device is currently unable to receive additional packets). In this case, the first packet in the transmit buffer 232 (associated with P0) cannot be transmitted and will remain in the transmit buffer 232 (e.g., blocking and delaying all of the other packets in the transmit buffer 232). Even if the packet is removed from the buffer after a pre-determined period of time (e.g., the packet “times out” and is flushed from the transmit buffer) other packets associated with P0 in the transmit buffer will eventually cause similar delays.

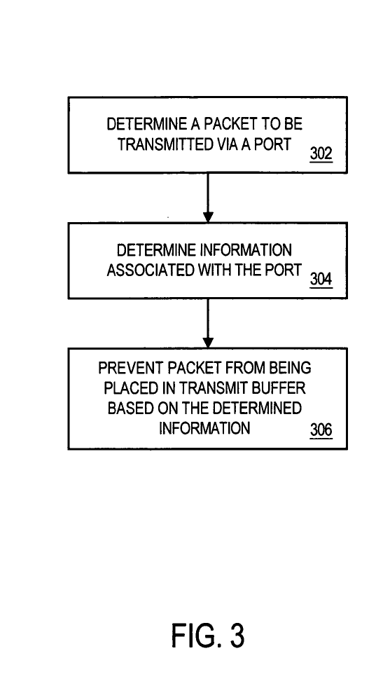

To reduce the chance of such delays, FIG. 3 is a flow chart of a method according to some embodiments. The method may be performed, for example, by an apparatus having a transmit buffer to store packets associated with a plurality of ports (such as the one described with respect to FIG. 2). The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine result in performance according to any of the embodiments described herein.

At 302, a packet to be transmitted via a port is determined. For example, a schedule processing element and/or a transmit processing element may receive an indication that a packet should be transmitted via a particular port (e.g., as selected during a pre-scheduler classification stage).

At 304, information associated with the port is determined. For example, whether or not that particular port is currently blocked may be determined by a transmit processing element. According to one embodiment, a hardware unit pools the status of each port and places the status (e.g., “0” indicating blocked and “1” indicating unblocked) in a control status register. That is, each bit in the control status register may reflect the current status of a port. The transmit processing element might then read the control status register to determine whether or not a particular port is blocked (e.g., by inspecting the bit associated with that port). According to another embodiment, the “information associated with the port” represents the total number of packets that are currently pending (e.g., that have been scheduled but not transmitted for any of the ports, including the port associated with this particular packet). Based on the information determined at 304, the packet is prevented from being placed in a transmit buffer at 306.

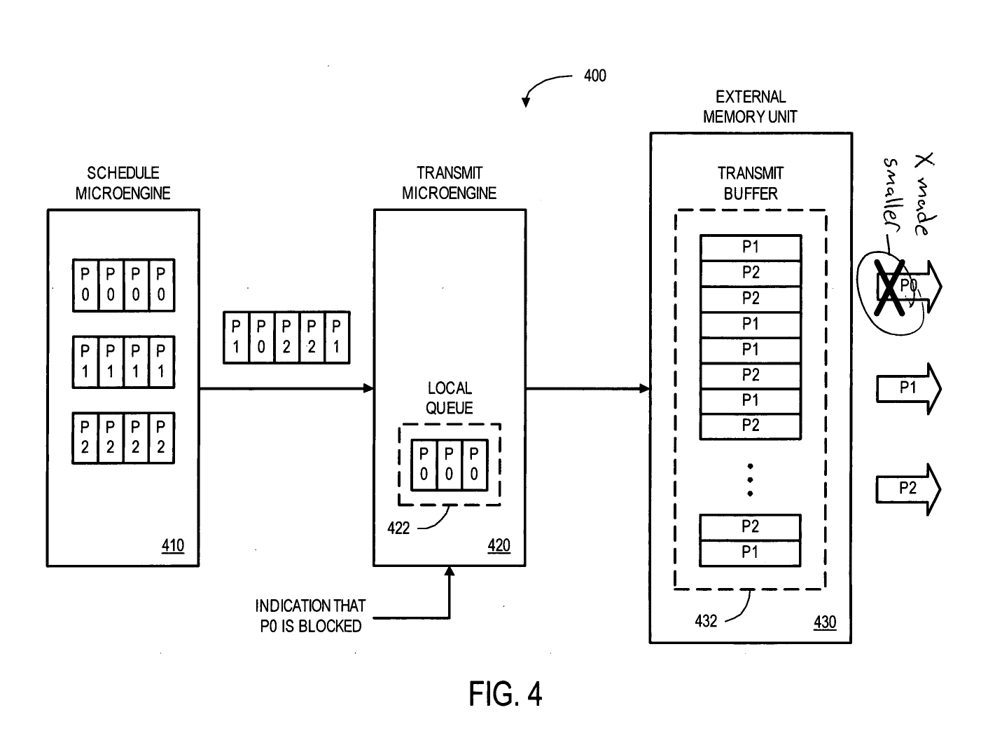

For example, FIG. 4 is a block diagram of an apparatus 400 according to some embodiments. In this case, the apparatus 400 includes a schedule microengine 410 (e.g., a multi-threaded, multi-processing RISC device) that provides to a transmit microengine 420 a series of packets that will be transmitted through a number of different ports (e.g., P0 through P2).

The transmit microengine 420 stores the packets in an external memory unit 430 that has a single transmit buffer 432 for a plurality of ports. That is, the transmit buffer 432 might include the following packets (identified by port): P0, P2, P2, P0, P1 . . . . A hardware unit may then retrieve the packets in order and arrange for the packets to be transmitted via the appropriate port.

According to this embodiment, the transmit microengine 420 also receives information indicating whether or not a port is currently blocked. For example, the transmit processing element may read information from a control status register to determine whether or not a particular port is blocked (e.g., by inspecting a bit associated with that port). As another example, when a packet associated with Px times out and is removed from the transmit buffer 432 without being successfully transmitted, the transmit microengine 420 might receive an indication that Px is currently blocked (e.g., a hardware unit might set a bit in a vector that is accessible by the transmit engine 420).

Based on such an indication, the transmit microengine 420 may begin to store packets associated with Px in a local buffer or queue 422. For example, as illustrated in FIG. 4 the transmit microengine 420 might store packets associated with P0 in the local queue 422 when it determines that P0 is currently blocked. In this way, additional packets associated with P0 (which would eventually result in additional time outs) are prevented from being placed in the transmit buffer 432 and unnecessary delays may be avoided. Note that although a single local queue 422 is illustrated in FIG. 4, the transmit microengine 420 could include multiple local queues (e.g., because more than one port might blocked at the same time).

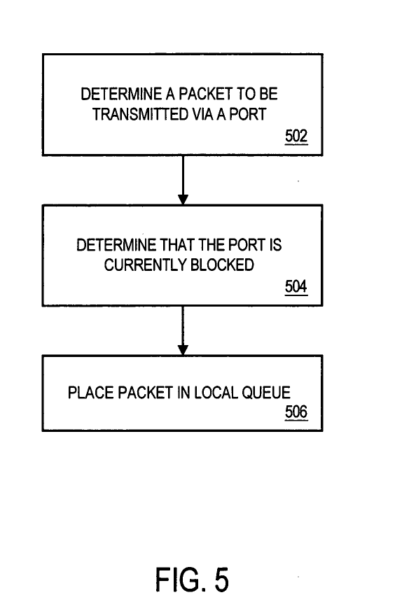

FIG. 5 is a flow chart of a transmit processing element method according to some embodiments. The method may be performed, for example, by the transmit microengine 420 described with respect to FIG. 4. At 502, a packet to be transmitted via a port is determined. For example, a transmit microengine may determine that a packet is to be transmitted via a particular port based on information received from a schedule microengine. Note that the outgoing port might have been selected and assigned to the packet during a pre-scheduling classification stage.

At 504, whether or not that particular port is currently blocked is determined. For example, the transmit microengine might maintain or retrieve a port status vector that indicates whether or not each port is currently blocked.

At 506, the packet is placed in a queue stored at the transmit microengine. In this way, the transmit microengine can prevent further packets associated with the blocked port from being placed into the transmit buffer. Note that a certain number of packets associated with the blocked port may have already been placed into the transmit buffer (e.g., before the transmit microengine received the indication that the port was blocked). In this case, the packets might be immediately removed from the transmit buffer or simply be allowed to time out when they reach the front of the FIFO transmit buffer.

The transmit microengine might eventually determine that the port is no longer blocked (e.g., when a downstream device is again ready to receive additional information packets). In this case, the transmit microengine may arrange for packets to be moved from the local queue to the transmit buffer.

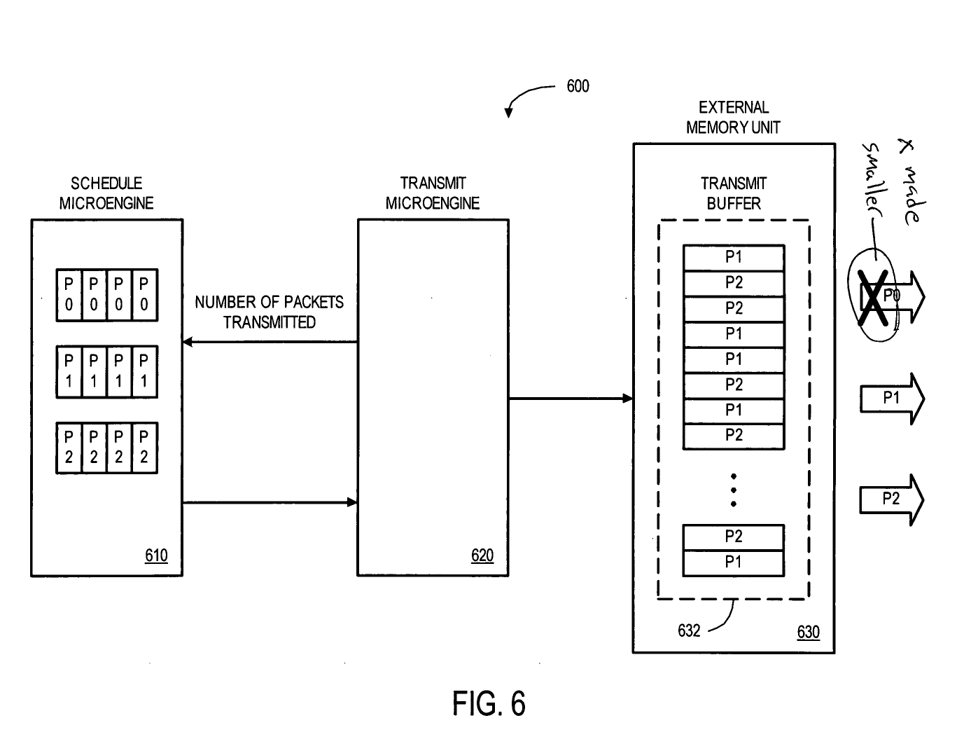

FIG. 6 is a block diagram of an apparatus 600 according to some embodiments. As before, the apparatus 600 includes a schedule microengine 610 that provides to a transmit microengine 620 a series of packets that will be transmitted through a number of different ports (e.g., P0 through P2).

The transmit microengine 620 stores the packets in an external memory unit 630 using a single FIFO transmit buffer 632. That is, the transmit buffer 632 might include the following packets (identified by port): P0, P2, P2, P0, P1 . . . . A hardware unit may then retrieve the packets in order and arrange for the packets to be transmitted via the appropriate port.

According to this embodiment, the schedule microengine 610 receives information indicating whether or not one or more ports may be currently blocked. For example, the schedule microengine 610 might receive from the transmit microengine 620 information indicating how may packet have been transmitted. The schedule microengine 610 may then calculate how may packets are “pending” (e.g., by subtracting the number of packets that have been transmitted from the number of packet that it has scheduled). Note that the transmit microengine 620 might count a packet that was flushed from the transmit buffer 632 as being “transmitted”—even though the packet was not successfully transmitted (e.g., because the packet should not be considered “pending”).

If the number of packets that are pending (e.g., for all ports) exceeds a pre-determined threshold, the schedule microengine 610 may determine that one or more ports are currently blocked. The schedule microengine 610 may then prevent additional packets from being scheduled for any port. For example, as illustrated in FIG. 6 the schedule microengine 610 may stop scheduling packets when it determined that too many packets are currently pending. In this way, the capacity of the local queue at the transmit microengine 620 might not be exceeded (that is, the local queue might not be asked to store more packets than it can handle).

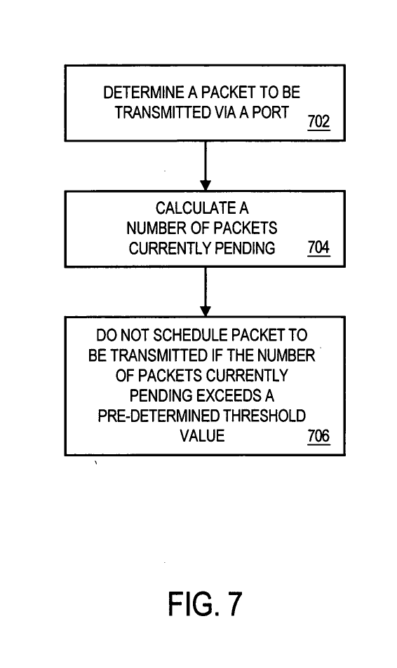

FIG. 7 is a flow chart of a schedule processing element method according to some embodiments. The method may be performed, for example, by the schedule microengine 610 described with respect to FIG. 6. At 702, a packet to be transmitted via a port is determined. For example, a schedule microengine may schedule a packet is to be transmitted via a particular port based on a selection made during a pre-scheduling classification stage.

At 704, a number of packets that are currently pending is calculated (e.g., representing the total number packets that have already been scheduled but not yet transmitted, also referred to as “in-flight” packets). According to other embodiments, different information may be used to determine that the port is currently blocked. For example, the schedule microengine might be notified when another packet associated with that port has been removed from the transmit buffer without being successfully transmitted. According to still another embodiment schedule microengine may maintain or retrieve a port status vector that indicates whether or not each port is currently blocked. According to yet another embodiment, the number of pending packets for a particular port might be calculated.

At 706, the schedule microengine does not schedule the packet to be transmitted when the number of packets that are currently pending exceeds a pre-determined threshold value (e.g., by not sending any additional packets to a transmit microengine). In this way, the schedule microengine might prevent the local queue at the transmit microengine from becoming full (in addition to preventing additional packets from being placed in the transmit buffer). As a result, the pre-determined threshold value may be based at least in part on the size of the local queue at the transmit microengine.

The schedule microengine might eventually determine that the number of packets pending has fallen below a threshold value (e.g., because packets are again being transmitted through a previously blocked port). In this case, the schedule microengine may resume scheduling packets (and sending the packets to a transmit engine).

Note that although packets are prevented from being stored in a transmit buffer by a transmit microengine in FIGS. 4 and 5 (e.g., because a port associated with a packet is blocked) and a schedule microengine in FIGS. 6 and 7 (e.g., because too many packets are in-flight), the two approaches may also be used together. That is, a transmit microengine may store a limited number of packets in a local queue and a schedule microengine may prevent further packets from being provided to the transmit microengine.

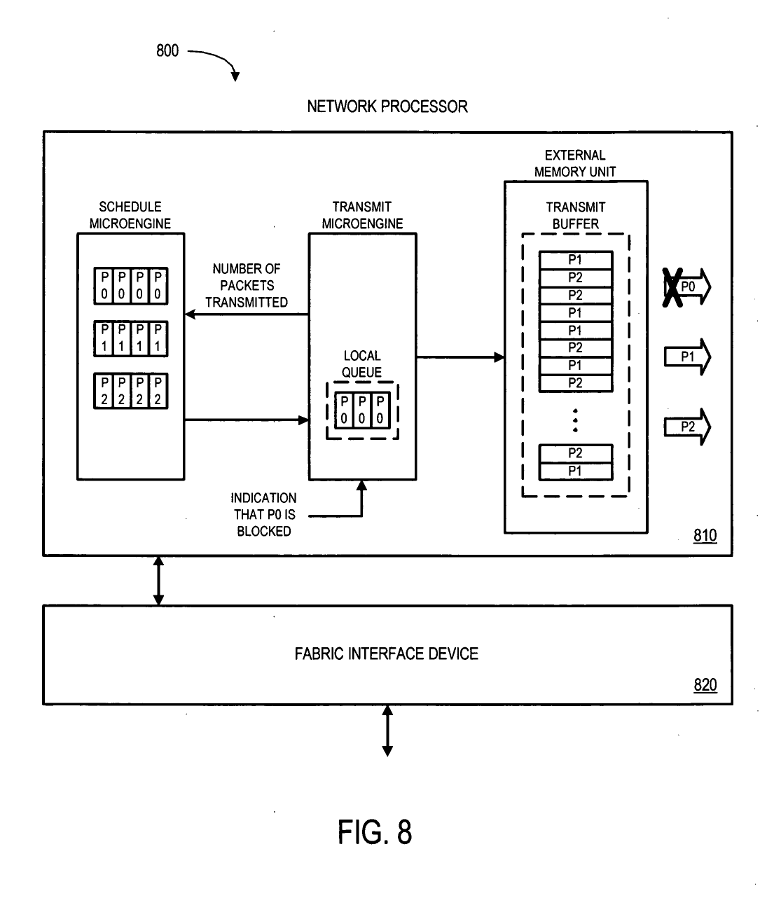

FIG. 8 is an example of a system 800 including a network processor 810 according to some embodiments. The network processor 810 may include a transmit buffer to store packets associated with a plurality of ports, a schedule microengine, and/or a transmit microengine according to any of the embodiments described herein. For example, the network processor 810 might include a transmit microengine that stores packets in a local queue when the packets are associated with a port that is currently blocked and/or a schedule microengine that prevents packets from being transmitted when too many packets are currently in-flight. The system 800 may further include a fabric interface device 820, such as a device to exchange ATM information via a network.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although a particular series of functional blocks (e.g., a schedule microengine and a transmit microengine) are described in some embodiments, other embodiments may include additional and/or other functional blocks. By way of example, a network processor may include a shaper block, a timer block, and/or a queue manager. Moreover, different functional blocks and/or stages might be implemented in different processing elements or in the same processing elements.

Similarly, although particular techniques have been described to determine if a port is currently blocked, any technique may be used instead. For example, a device might monitor downstream devices and/or traffic flow to determine if a port is currently blocked.

In addition, although a single FIFO transmit buffer has been illustrated, note that embodiments could include multiple transmit buffers. For example, a first transmit buffer might be provided for ports P0 through P3 while a second transmit buffer is provided for ports P4 through P7.

The several embodiments described herein are solely for the purpose of illustration. Persons skilled in the art will recognize from this description other embodiments may be practiced with modifications and alterations limited only by the claims.

1. A method, comprising:
determining a packet to be transmitted via a port;
determining information associated with the port; and
preventing the packet from being placed in a transmit buffer based on the determined information, wherein the transmit buffer stores packets associated with a plurality of ports.

2. The method of claim 1, wherein the transmit buffer is a first-in, first-out buffer.

3. The method of claim 1, wherein the determinations are performed by a transmit processing element, and the transmit buffer is stored in a memory unit external to the transmit processing element.

4. The method of claim 3, wherein the information associated with the port is a port status indicating that the port is currently blocked.

5. The method of claim 3, wherein the determination of information associated with the port comprises:
accessing a control status register and evaluating a bit associated with the port.

6. The method of claim 5, wherein the determination of information associated with the port comprises detecting that another packet to have been transmitted via the port was removed from the transmit buffer without being successfully transmitted.

7. The method of claim 3, wherein said preventing comprises:
placing the packet in a local queue stored at the transmit processing element.

8. The method of claim 7, further comprising:
determining that a port status indicates that the port is not currently blocked; and
arranging for the packet to be moved from the local queue to the transmit buffer.

9. The method of claim 7, wherein determination of the packet to be transmitted comprises receiving the packet from a schedule processing element.

10. The method of claim 1, wherein the determinations are performed by a schedule processing element.

11. The method of claim 10, wherein the determination of information associated with the port comprises:
receiving an indication of a number of packets that have been transmitted;
calculating a number of packets that are pending; and
comparing the number of packets that are pending with a pre-determined threshold value.

12. The method of claim 10, wherein said preventing comprises:
not scheduling the packet to be transmitted.

13. The method of claim 12, further comprising:
determining that a number of packets that are pending is below a pre-determined threshold value; and
scheduling the packet to be transmitted.

14. The method of claim 13, wherein the scheduling includes:
providing the packet to a transmit processing element.

15. An article, comprising:
a storage medium having stored thereon instructions that when executed by a machine result in the following:
determining a packet to be transmitted via a port;
determining information associated with the port; and
preventing the packet from being placed in a transmit buffer based on the determined information, wherein the transmit buffer stores packets associated with a plurality of ports.

16. The article of claim 15, wherein the transmit buffer is a first-in, first-out buffer.

17. The article of claim 15, wherein the determinations are performed by a transmit processing element, and the transmit buffer is stored in a memory unit external to the transmit processing element.

18. The article of claim 17, wherein the information associated with the port is a port status indicating that the port is currently blocked.

19. The article of claim 17, wherein the determination of information associated with the port comprises:
accessing a control status register and evaluating a bit associated with the port.

20. The article of claim 19, wherein the determination of information associated with the port comprises detecting that another packet to have been transmitted via the port was removed from the transmit buffer without being successfully transmitted.

21. The article of claim 17, wherein said preventing comprises:
placing the packet in a local queue stored at the transmit processing element.

22. The article of claim 17, wherein determination of the packet to be transmitted comprises receiving the packet from a schedule processing element.

23. The article of claim 15, wherein the determinations are performed by a schedule processing element.

24. The article of claim 23, wherein the determination of information associated with the port comprises:
receiving an indication of a number of packets that have been transmitted,
calculating a number of packets that are pending, and
comparing the number of packets that are pending with a pre-determined threshold value.

25. The article of claim 23, wherein said preventing comprises:
not scheduling the packet to be transmitted.

26. An apparatus, comprising:
a transmit processing element to provide packets to be transmitted via a plurality of ports; and
a memory external to the transmit processing element to store the packets in a transmit buffer,
wherein the transmit processing element includes a local queue to store packets to be transmitted via a port that is currently blocked.

27. The apparatus of claim 26, wherein the transmit processing element determines that a port is currently blocked by accessing a control status register and evaluating a bit associated with the port.

28. The apparatus of claim 27, further comprising:
a schedule processing element to provide the packets to the transmit processing element, wherein the schedule processing element prevents a packet from being provided to the transmit processing element when a number of packets that are pending exceeds a predetermined threshold value.

29. An apparatus, comprising:
a schedule processing element to provide packets to be transmitted via a plurality of ports;
a transmit processing element to receive the packets; and
a memory external to the transmit processing element to store the packets in a transmit buffer,
wherein the schedule processing element prevents a packet from being provided to the transmit processing element when a number of packets that are pending exceeds a pre-determined threshold value.

30. The apparatus of claim 29, wherein the schedule processing element is to receive from the transmit processing element an indication of a number of packets that have been transmitted and the determination of whether the port is currently block is based on: (i) the received indication, (ii) a number of packets that that have been scheduled, and (iii) the pre-determined threshold value.

31. A system, comprising:
a network processor, including:
a transmit processing element to provide packets to be transmitted via a plurality of ports, and
a memory external to the transmit processing element to store the packets in a transmit buffer,
wherein the transmit processing element includes a local queue to store packets to be transmitted via a port that is currently blocked; and
an asynchronous transfer mode fabric interface device coupled to the network processor.

32. The system of claim 31, wherein the transmit processing element determines that a port is currently blocked by accessing a control status register and evaluating a bit associated with the port.

33. The system of claim 31, wherein the network processor further includes:
a schedule processing element to provide the packets to the transmit processing element, wherein the schedule processing element prevents a packet from being provided to the transmit processing element when a number of packets that are pending exceeds a pre-determined threshold value.
